(19) United States
(12) Patent Application Publication
(10) Pub. No.: US 2005/0001440 A1
(43) Pub. Date: Jan. 6, 2005

(54) Compressed gas tank carrier

(76) Inventor: James K. Hartwell, Ruskin, FL (US)

Correspondence Address: DONALD R. BAHR, 2608 MERIDA LN, TAMPA, FL, 33618, US

(21) Appl. No.: 10/612,183

(22) Filed: Jul. 3, 2003

(51) Int. Cl. B65G 7/12

(52) U.S. Cl. 294/137

(57) ABSTRACT

A compressed gas tank carrier which has a closed loop design. The closed loop design has a primary section which is adapted to engage a human hand and a secondary section which is adapted to engage a valve assembly which is integral with the upper terminal end of the compressed gas tank. When the compressed gas tank carrier engages the valve assembly it functions as a convenient handle for engaging and carrying the compressed gas tank. The compressed gas tank carrier is particularly suited for use with scuba tanks. The compressed gas tank carrier may be inexpensively formed from thermoplastic polymeric materials and may have an I shaped cross section.

### BACKGROUND OF THE INVENTION

Gas for various purposes is compressed and stored under high pressure in steel cylinders. The pressure in these tanks can often exceed 5000 p.s.i. as a result of this pressure the storage tanks utilized must be very strong in order to withstand the internal pressure. Making the compressed gas tanks strong entails making tanks with thick wall sections which in turn means the tanks are heavy. Because the tanks are heavy they are difficult to handle. This invention is particularly concerned with scuba tanks which must be handled under adverse conditions i.e. on a rocking small boat. This invention deals with a handle device whereby small compressed gas tanks can be easily handled. The handle of this invention is a closed loop device which is adapted to grip the valve assembly, through which the tank is charged and through which gas is removed from the tank.

### OBJECTS OF THE INVENTION

The primary object of this invention is a simple device whereby a compressed gas tank and in particular a scuba tank may be carried.

Another object of this invention is a carrying handle which is adapted to engage the valve of a compressed gas tank whereby the carrying handle allows for the convenient carrying of the compressed gas tank.

Still another object of this invention is a simple inexpensive carrying handle for a compressed gas tank.

### DESCRIPTION OF THE DRAWINGS

For a more complete understanding of the nature, objects and advantages of the present invention, reference should be had to the following detailed description taken in conjunction with the accompanying drawings in which:

FIG. 1 is a perspective illustration of a tank carrying handle constructed in accordance with the principles of the present invention,

FIG. 2 is a right hand side elevation view showing components of a scuba tank,

FIG. 3 is a rear view of the carrying handle as shown in FIG. 1 attached to a scuba tank,

FIG. 4 is a side view of the carrying handle as shown in FIG. 1 attached to a scuba tank,

FIG. 5 is a cross section along line 5-5 of FIG. 1,

### BRIEF DESCRIPTION OF THE INVENTION

Small compressed gas tanks are in widespread usage, for example in the medical field and in sport field. Sport diving is usually referred to as scuba diving and the tanks used therein are referred to as scuba tanks. To date there has been no convenient way to carry these compressed gas tanks other than man handling the tanks around the tank body or, gripping the valve assembly with two or more fingers. The latter mentioned method gripping the valve assembly is usually very uncomfortable as the total weight of the tank is supported on just two fingers.

This invention deals with a tank carrier which will grip the valve assembly of a compressed gas tank and distribute the load over the total human hand. The tank carrier of this invention comprises a closed loop unitary structure having a first primary section and a secondary section. The first primary section is of such a size that it can be conveniently gripped by a human hand. The secondary section is adapted to engage the compressed gas tank. More particularly the secondary section is adapted to engage a portion of the valve of the compressed gas tank which is at right angles to the axis of the tank. The inside of the primary section may incorporate a plurality of grooves which may engage one of more fingers of a users hand.

The portion of the primary section which is opposite the terminal end of the secondary section is essentially linear and has a width which approximates the width of an adult human hand.

### DESCRIPTION OF THE PREFERRED EMBODIMENT

As is briefly discussed above this invention relates to a closed loop structure which is particularly suited for carrying compressed gas tanks and in particular metal tanks which are used in scuba diving. These tanks are generally referred to as scuba tanks. While the carrier of this invention can be used with all types of compressed gas tanks, the following discussion will be directed primarily to a tank carrier which is suitable for carrying scuba tanks and the problems associated with the carrying of scuba tanks.

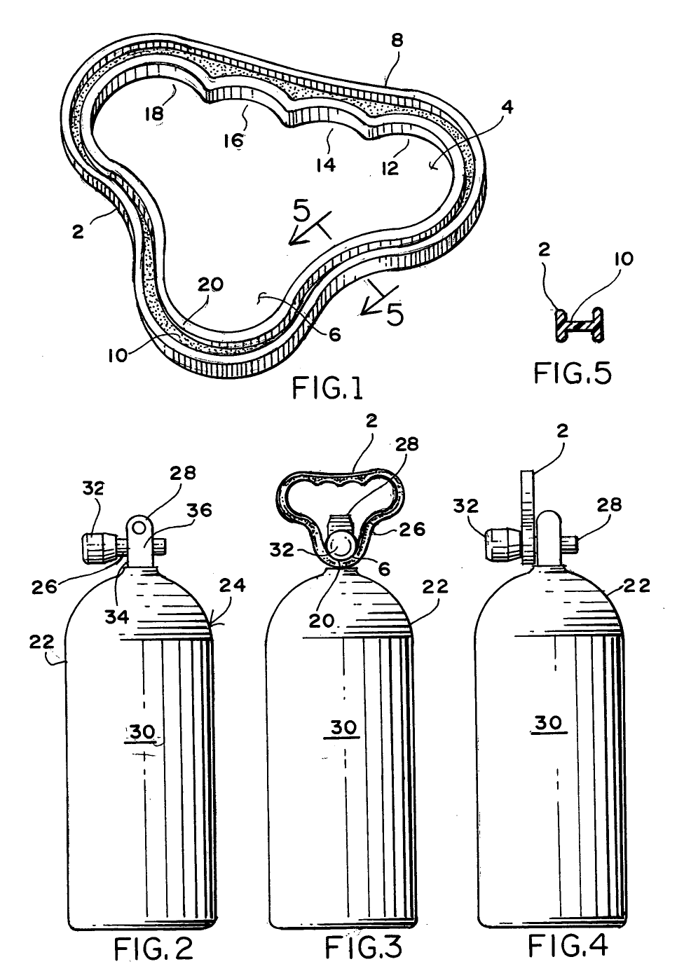

Referring to FIG. 1 which is a perspective view showing the compressed gas tank carrier 2 of this invention. As can be seen tank carrier 2 incorporates a closed loop design. Tank carrier 2 has a primary section 4 and a secondary section 6. Primary section 4 is of such a size and structure that it can be gripped by an adult human hand.

Tank carrier 2 has a first end 8 and a second end 10 which are opposite each other. First end 8 is essentially linear and has a width which is slightly larger than the width of an adult hand. The inside of first end 8 may further incorporate a plurality of arcuate sections 12,14,16 and 18 which are adapted to engage four fingers of an adult human hand. The radius of arcuate sections 12,14,16 and 18 approximates the radius of four adult human fingers.

Second end 6 of tank carrier 2 is opposite first end 8. Second end 6 terminates in a half circle 20. The radius of half circle 20 is slightly larger than the radius of the horizontal portion of the scuba tank valve.

The structure of a scuba tank is best understood by referring to FIG. 2. From FIG. 2 it can be seen that scuba tank 22 comprises a tank section 24 and a valve section 26. Valve section 26 comprises a vertical segment 28, the axis of which is parallel with the axis of tank section 30. Valve assembly 26 further incorporates a horizontal segment 32, the axis of which is at right angles to the axis of tank section 30. It is this horizontal segment 32 which second end 6 of tank carrier 2 is adapted to engage.

As can be seen from FIG. 3 the radius of half circle 20 of second end 6 approximates the radius of horizontal segment 32 of valve section 26.

The portion of second end 6 where second end 6 and first end 8 join may be flared. This flaring permits the easy centering of carrier 2 onto horizontal segment 32 of valve section 26.

The positioning of tank carrier 2 on valve section 26 of tank 22 is further illustrated in FIGS. 5, 3 and 4.

From FIGS. 2 and 3 it can be seen that terminal end 20 of secondary section 6 engages the lower extremity of horizontal segment 32 of valve assembly 26. With this engagement terminal end 20 binds into the right angle 34 which is formed by the junction of horizontal segment 32 with vertical segment 36 of valve assembly 26. In the preferred embodiment tank carrier 2 is formed from a thermoplastic. Because valve assembly 26 is formed from metal usually brass it is much harder than the thermoplastic tank carrier 2. As a result of this hardness differential terminal end 20 tends to deform and bind onto valve assembly 26. This binding prevents the disengagement of tank carrier 2 from valve assembly 26. With the engagement of terminal end 20 of tank carrier 2 with valve assembly 26, by applying upward pressure on tank carrier 2, tank 36 can be conveniently lifted and moved.

Because of the simple nature of tank carrier 2 and the fact that it can be formed from polymeric materials the tank carrier of this invention are relatively inexpensive to manufacture.

As a result of this fact it is feasible to provide each tank with its own tank carrier.

In order to aid in the engagement and positioning of tank carrier 2 with and on valve assembly 26 the portion of tank carrier 2 approximate the junction of first end 6 with second end 8 may be flared. This flaring is shown in FIG. 1 allows tank carrier 2 to be easily guided in to engagement with valve assembly 26.

As is shown in FIG. 5 in the preferred embodiment tank carrier 2 has an I shaped cross section. An I shaped cross section allows for maximum strength.

In the preferred embodiment tank carrier 2 is formed from a thermoplastic material such as polyethylene, polypropylene, a nylon etc. If extra strength is desired fiber filled thermoplastics may be used to form tank carrier 2.

In the preferred embodiment tank carrier 2 is formed from high density polyethylene by injection molding.

The above description and drawings are illustrative of modifications that can be made without departing from the present invention, the scope of which is to be limited only by the following claims.

1. A tank carrier which is particularly suited for carrying a rigid compressed gas tank comprising: a unitary rigid closed loop structure having a primary section and a secondary section, wherein the primary section is adapted to be engaged by a human hand and the secondary section is adapted to engage the valve assembly of a compressed gas tank.

2. The tank carrier of claim 1 wherein the portion of the primary section opposite the secondary section is essentially linear.

3. The tank carrier of claim 1 wherein the inner edges of the secondary section approximate the primary section are flared outward.

4. The tank carrier of claim 1 wherein the inner side of the primary section opposite the secondary section incorporates a plurality of arcuate grooves which approximate the diameter of human fingers,

5. The tank carrier of claim 2 wherein the inner side of the primary section opposite the secondary section incorporates a plurality of arcuate grooves which approximate the diameter of human fingeres.

6. The tank carrier of claim 3 wherein the inner side of the primary section opposite the secondary section incorporates a plurality of arcuate grooves which approximate the diameter of human fingers.

7. The tank carrier of claim 1 wherein the inner side of the secondary section is arcuate and is adapted to engage a portion, of a compressed gas tank valve, the axis of which is at right angles to the axis of the compressed gas tank.

8. The tank carrier of claim 2 wherein the inner side of the secondary section is.

9. The tank carrier of claim 3 wherein the inner side of the secondary section is arcuate and is adapted to engage a portion of a compressed gas tank valve, the axis of which is at right angles to the axis of the compressed gas tank.

10. The tank carrier of claim 4 wherein the inner side of the secondary section is arcuate and is adapted to engage a portion of a compressed gas tank valve, the axis of which is at right angles to the axis of the compressed gas tank

11. The tank carrier of claim 5 wherein the inner side of the secondary section is arcuate and is adapted to engage a portion of a compressed gas tank valve, the axis of which is at right angles to the axis of the compressed gas tank.

12. The tank carrier of claim 6 wherein the inner side of the secondary section is arcuate and is adapted to engage a portion of a compressed gas tank valve, the axis of which is at right angles to the axis of the compressed gas tank.

13. The tank carrier of claim 1 wherein said device is formed from a rigid polymeric material.

14. The tank carrier of claim 7 wherein said device is formed from a rigid polymeric material.

15. The tank carrier of claim 8 wherein said device is formed from a rigid polymeric material.

16. The tank carrier of claim 8 wherein said device is formed from a rigid polymeric material.

17. The tank carrier of claim 9 wherein said device is formed from a rigid polymeric material.

18. The tank carrier of claim 10 wherein said device is formed from a rigid polymeric material.

19. A tank carrier which is particularly suited for carrying a compressed gas tank comprising: a unitary closed loop structure having a linear primary section and a secondary section which is opposite the primary section wherein the inner side of the primary section is adapted to be engaged by a human hand and the inner side of the secondary section is arcuate and is adapted to engage the portion of a compressed gas tank valve which is at right angles to the axis of said compressed gas tank.

20. The handle device of claim 19 wherein the handle device has an I shaped cross section and is formed from a rigid polymeric material.
